(19) United States
(12) Patent Application Publication
(10) Pub. No.: US 2005/0112420 A1
(43) Pub. Date: May 26, 2005

(54) Power supply device

(75) Inventors: Chiou-Chu Lai, Taipei (TW); Yuh-Fwu Chou, Taipei (TW); Sheng-Yong Shen, Yunlin (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 10/990,466

(22) Filed: Nov. 18, 2004

(30) Foreign Application Priority Data
Nov. 26, 2003 (TW) 92133136

(51) Int. Cl. H01M 16/00; H01M 10/44; H01M 10/46; H01M 8/04; H02J 7/00

(52) U.S. Cl. 429/13; 320/101; 429/9; 429/23; 429/50; 320/162

(57) ABSTRACT

A power supply device comprises a secondary cell group and a fuel cell group. The secondary cell group has an operative voltage range and may receive a voltage converted from a voltage converter that coupled to the fuel cell group. The fuel cell group is characterized with a maximum output power and a corresponding voltage. The corresponding voltage is not higher than the upper limit of the operative voltage range.

### BACKGROUND

The present invention relates to a power supply device, and more particularly to a power supply device with a secondary cell group and fuel cell group collocated therein.

A fuel cell (FC) converts the chemical energy of hydrogen and oxygen to electricity. Compared to conventional power generation devices, the FC produces less pollution and noise, and has higher energy density and energy conversion efficiency. The FC provides clean energy, and can be used in portable electronic devices, transportation, military equipments, power generating systems or the space industry, among many other applications.

Since the power supply process of the FC involves conversion of reactants and products and electronic current, the output voltage of the FC is affected by load. When the load requires a larger current, the response speed of the FC must be increased to supply enough current. The FC has difficulty supplying the required larger current quickly. Thus, power failure occurs in the FC.

In order to avoid the power failure, the FC usually utilizes a capacitor or a secondary cell supplying a transient larger current to the load when the load is changed. A capacitor supplies only a short pulse current such that a secondary cell is preferred to drive the load.

The secondary cell is a rechargeable cell, for example, lithium ion secondary battery, nickel-metal hydride battery, or lead acid battery. The secondary cell has an operative voltage range having a maximum voltage and a minimum voltage.

When receiving an input voltage exceeding the maximum voltage, the secondary cell is charged to above the maximum voltage, and when outputting an output voltage less than the minimum voltage, the secondary cell is discharged to less than the minimum voltage. When the secondary cell is charged to above the maximum voltage or discharged to less than the minimum voltage, the secondary cell will fire or be damaged.

Since the output voltage from the FC may be above the maximum voltage or less than the minimum voltage, the FC utilizes a DC/DC converter to convert the output voltage to a preset voltage within the operative voltage range accepted by the secondary cell. The DC/DC converter outputs the preset voltage to the secondary cell to avoid fire or damage events in the secondary cell.

FIGS. 1 and 2 show a fuel cell (FC) group and a secondary cell group. Curve A shows an output voltage from the secondary cell group and curve B an output voltage from the fuel cell group. In FIG. 1, the output voltage from the fuel cell group is less than the output voltage from the secondary cell group such that a boost converter is applied to increase the output voltage from the fuel cell group. In FIG. 2, the output voltage from the secondary cell group both rises above and falls less than the output voltage from the fuel cell group, such that a boost and buck converter is applied to adjust the output voltage from the fuel cell group.

The DC-DC converter changing the output voltage from the fuel cell group to the operative voltage range of the secondary cell group, however, does increase power waste, with the effect increased when voltage difference between the output voltage from the fuel cell group and the output voltage from the secondary cell group is higher. A high effect DC-DC converter solves power waste problems but is costly.

### SUMMARY

An embodiment of the invention provides a power supply method, in which a secondary cell group having an operative voltage range is provided, followed by a fuel cell group characterized by a preset output power and a corresponding voltage is provided. The fuel cell group is adjusted to bring the corresponding voltage within the operative voltage range.

A power supply device comprises a secondary cell group and a fuel cell group. The secondary cell group has an operative voltage range. The fuel cell group comprises a preset output power and a corresponding voltage within the operative voltage range.

### BRIEF DESCRIPTION OF THE DRAWINGS

Embodiments of the present invention can be more fully understood by reading the subsequent detailed description and examples with reference made to the accompanying drawings, wherein:

FIGS. 1 and 2 show the I-V characteristics of a fuel cell (FC) group and a secondary cell group;

FIG. 3 is a curve diagram of the fuel cell group, presenting power and voltage;

FIG. 4 is a block diagram of a power supply device according to a first embodiment of the present invention;

FIG. 5a is a block diagram of a power supply device according to a second embodiment of the present invention;

FIG. 5b is a circuit diagram according to the second embodiment of the present invention;

FIG. 6 is a curve diagram of the fuel cell group, presenting current and voltage;

FIG. 7a is a block diagram of a power supply device according to a third embodiment of the present invention;

FIG. 7b is a circuit diagram according to the third embodiment of the present invention;

FIG. 8 is a block diagram of a power supply device according to a fourth embodiment of the present invention;

FIG. 9 is a block diagram of a power supply device according to a fifth embodiment of the present invention;

FIG. 10a is a first circuit diagram according to the fifth embodiment of the present invention;

FIG. 10b is a second circuit diagram according to the fifth embodiment of the present invention;

FIG. 10c is a third circuit diagram according to the fifth embodiment of the present invention; FIG. 10d is a fourth circuit diagram according to the fifth embodiment of the present invention.

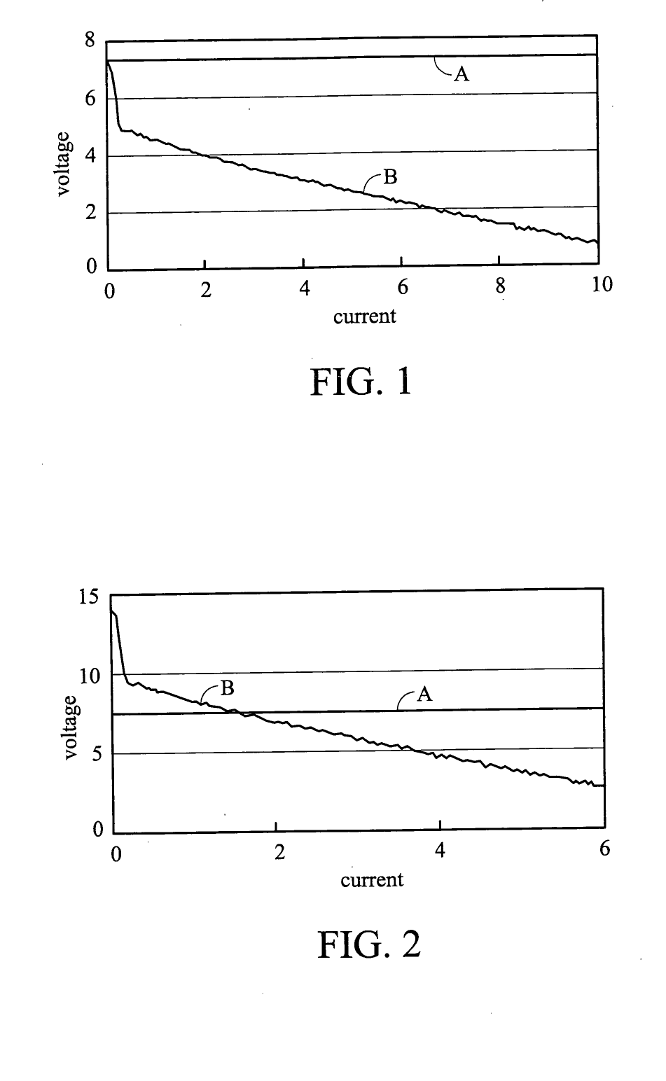

### DETAILED DESCRIPTION

An output voltage of fuel cells is determined by a current required by a load. When the load requires a higher current, the output voltage from fuel cells would decrease due to the constant chemical reaction rate in the fuel cells. Methanol fuel cells are described herein as an example. The output voltage of one methanol fuel cell is about 0.7V, when the methanol fuel cell is not driving a load. The output voltage of one methanol fuel cell is about 0.25V, when the methanol fuel cell is driving and providing its maximum power to the load. In embodiments of the present invention, an operative voltage range of a secondary cell group is between 6.5V and 8.4V. In other words, the maximum operative voltage of a secondary cell group is 8.4V and the minimum operative voltage thereof 6.5V.

Embodiment of the present invention adjusts the output voltage of a fuel cell corresponding to the maximum power to less than or equal to the maximum operative voltage of the secondary cell group. For example, if a fuel cell group comprises, but is not limited to, thirty fuel cells connected in series, output voltage from the fuel cell group at a maximum power is within the operative voltage range of a secondary cell group. In case that the corresponding output voltage from the fuel cell group at a maximum power is not within the operative voltage range of the secondary cell group, manufacture may change or adjust the number of the fuel cells connected in series to make the corresponding output voltage within that operative voltage range.

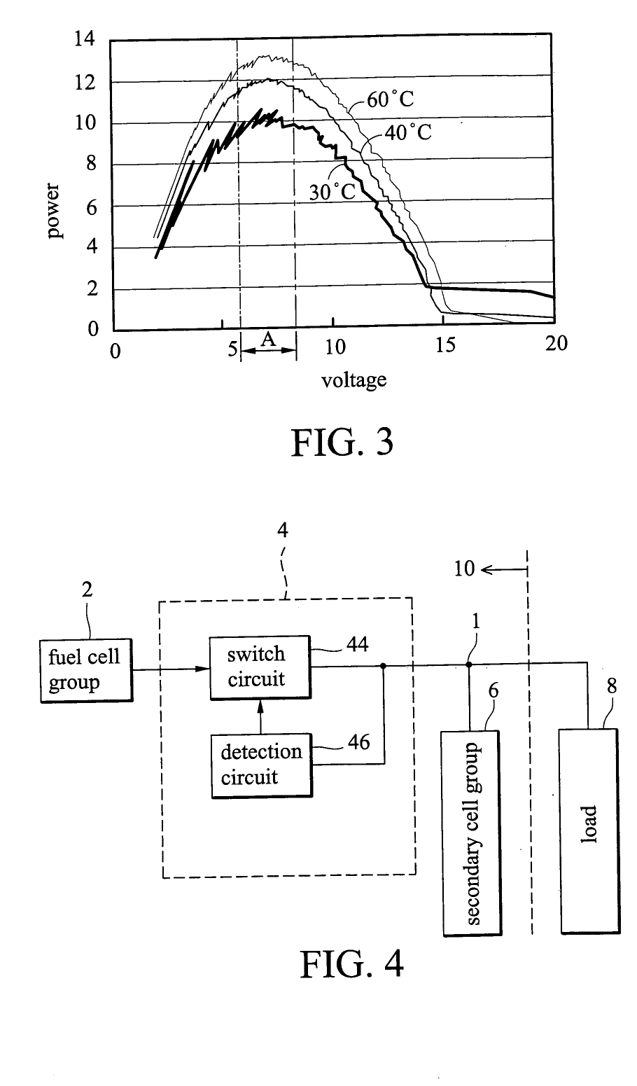

FIG. 3 is a power-voltage curve diagram of the fuel cell group. At different temperatures, the curve does not substantially change. When the fuel cell group is designed to provide maximum power with the corresponding output voltage within an operative voltage range A, the fuel cell group operates with best utilization. It therefore approaches the major goal of this invention.

### First Embodiment

FIG. 4 is a block diagram of a F.C. power supply device according to a first embodiment of the present invention. The power supply device 10 provides a driving current to a load 8 and comprises a fuel cell group 2, a control unit 4, and a secondary cell group 6. The secondary cell group 6 has an operative voltage range with maximum and minimum operative voltages.

In this embodiment, the secondary cell group 6 comprises batteries, for example, lithium ion secondary, nickel-metal hydride, or lead acid batteries. Fuel cell group 2 comprises direct methanol fuel cells. The number of direct methanol fuel cells determines the voltage output from the fuel cell group 2. When the fuel cell group 2 provides maximum power, its corresponding output voltage would be equal or less than the maximum operative voltage of the secondary cell group 6.

The control unit 4 is coupled between the fuel cell group 2 and the secondary cell group 6 and comprises a switch circuit 44 and a detection circuit 46. The switch circuit 44 is coupled between the fuel cell group 2 and the secondary cell group 6. The detection circuit 46 detects at node 1 an output voltage from the secondary cell group 6 and determines whether the switch circuit 44 is turned on.

When the load 8 requires a large current, the output voltage from the secondary cell group 6 is reduced. The detection circuit 46 turns on the switch circuit 44 when the output voltage from the secondary cell group 6 is less than a first preset voltage. Thus, the fuel cell group 2 directly provides an output voltage to the secondary cell group 6 and the load 8.

When the load 8 does not require a large current, the output voltage from the secondary cell group 6 is increased. The detection circuit 46 turns off the switch circuit 44 when the output voltage from the secondary cell group 6 exceeds a second preset voltage. Thus, the load 8 receives only the current output from the secondary cell group 6. Additionally, the first preset voltage and the second preset voltage are within the operative voltage range of the secondary cell group 6.

### Second Embodiment

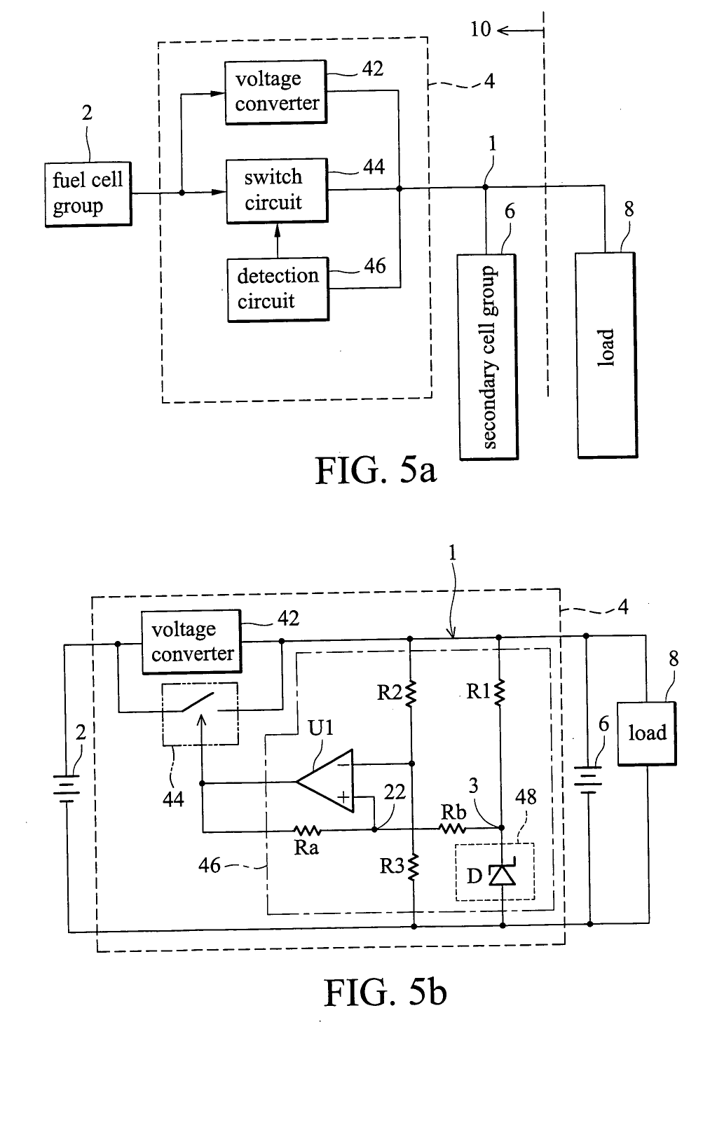

FIG. 5a is a block diagram of a power supply device according to a second embodiment of the present invention. The control unit 4 further comprises a voltage converter 42 coupled between the fuel cell group 2 and the secondary cell group 6.

The voltage of node 1 represents the voltage output from the secondary cell group 6. When voltage at node 1 exceeds the second preset voltage, the switch circuit 44 is turned off. Instead to directly charge the secondary cell group 6, the output power of the fuel cell group 2 is converted by the voltage converter 42 to have an output voltage within the operative voltage range and provides the set voltage to the secondary cell group 6 and the load 8.

When the voltage of the node 1 is less than the second preset voltage, the switch circuit 44 is turned on, outputting the voltage output from the fuel cell group 2 directly to the secondary cell group 6 and the load 8, The second preset voltage can be equal or higher than the first preset voltage.

FIG. 5b is a circuit diagram according to the second embodiment of the present invention. The detection circuit 46 comprises resistor R1˜R3, Ra, and Rb, a comparator U1, and a processing unit 48. The processing unit 48 can be a zener diode D whose breakdown voltage provides a reference voltage.

The resistor R1 limits current into the zener diode D. When the current into the zener diode D is maintained within a current range, the breakdown voltage is also maintained at an immobile value. The resistors R2 and R3 are connected to act as a potential divider. The resistors Ra and Rb generate the first preset voltage and the second preset voltage according to hysteresis effect.

The voltage converter 42 is a step-down converter converting voltage output from the fuel cell group 2 to a set voltage within the operative voltage range of the secondary cell group 6, such as linear DC voltage regulator circuit or switching power converter. The switch circuit 44 can be a transistor or a relay switch.

Since the resistors Ra and Rb exhibit the hysteresis effect, the first preset voltage and the second preset voltage are generated in a node 22. The comparator U1 comprises a positive terminal and a negative terminal. When voltage of the positive terminal exceeds that of the negative terminal, the comparator U1 outputs a high voltage to turn on the switch circuit 44. When voltage of the positive terminal is less than that of the negative terminal, the comparator U1 outputs a low voltage to turn off the switch circuit 44.

In this embodiment, the high voltage is 5V, the low voltage is 0V, resistances of resistors Ra and Rb are respectively 240 KQ and 10 KQ, and the breakdown voltage of the zener diode is 4.167V. When the comparator U1 outputs a high voltage, voltage of the node 22 is 4.2V, representing the second preset voltage. When the comparator U1 outputs a low voltage, voltage of the node 22 is 4.0V, representing the first preset voltage.

If the comparator U1 outputs a high voltage, voltage of the node 22 is 4.2V. When the output voltage of the secondary cell group 6 is gradually increased from less than 8.4V because of the direct charging from the fuel cell group 2, voltage of the negative terminal gradually increases. When voltage of the negative terminal exceeds that of the positive terminal, the comparator U1 outputs a low voltage, simultaneously changing voltage of node 22 from 4.2V to 4.0V.

If the comparator U1 outputs a low voltage, the voltage of the node 22 is 4.0V. When the output voltage of the secondary cell group 6 is gradually reduced from above 8.0V due to the power consumption of the load 8, voltage of the negative terminal is gradually reduced. When voltage of the negative terminal is less than that of the positive terminal, the comparator U1 outputs a high voltage, changing voltage of node 22 from 4.0 v to 4.2V.

When voltage of the negative terminal exceeds that of the positive terminal, the switch circuit 44 is turned off, forcing the secondary cell group 6 and the load 8 to receive the power provided by the the fuel cell group 2 only through the conversion of the voltage converter 42, as shown in FIG. 5b. When voltage of the negative terminal is less than the voltage of the node 22, the switch circuit 44 is turned on, directly outputting the voltage output from the fuel cell group 2 to the secondary cell group 6 and the load 8.

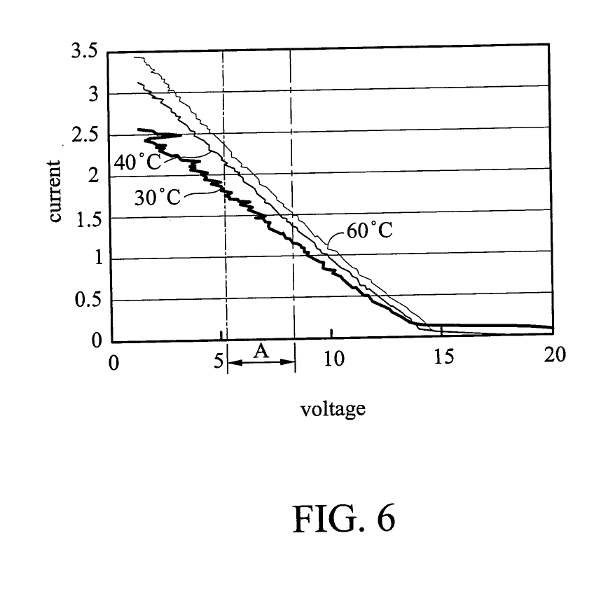

FIG. 6 is an I-V curve diagram of the fuel cell group 2, in which different curves refer to different temperatures. As shown in FIGS. 6, it is natural for a fuel cell group that its output current decreases as its voltage output increases. In FIG. 6, when the driving current provided by the fuel cell group 2 is 1 A, the output voltage is about 9V, and when the driving current provided by the fuel cell group 2 is 1.3 A, the output voltage is about 7.8V.

When current required by the load 8 is increased, the output voltage of the secondary cell group 6 may go down because the secondary cell group 6 is discharged. At the moment when the voltage at node 22 is higher than that at the negative terminal of comparator U1, comparator U1 turns on switch circuit 44, making fuel cell group 2 directly power the load 8. The output voltage of the fuel cell group 2 may be reduced due to a high output driving current.

When the current required from the load 8 is reduced, the output voltage from the fuel cell group 2 increases, such that voltage of the negative terminal may exceed the positive terminal. At the moment when the voltage of the negative terminal of the comparator U1 exceeds the positive one, the switch circuit 44 is turned off, cutting the direct connection between the fuel cell group 2 and the secondary cell group 6, and the voltage converter 42 converts the output voltage from the fuel cell group 2 to a set voltage to power the load 8 or charge the secondary cell group 6.

Using a curve whose corresponding temperature is 30 degrees as an example and supposing that the secondary cell group 6 has an operative voltage range A with the maximum operative voltage of 8.4V, which is not less than the voltage of the fuel cell group 2 at a maximum power as shown in FIG. 3. If a driving current provided by the fuel cell group 2 is 1 A, the voltage output from the fuel cell group 2 is 9V, as shown in FIG. 6. Providing that the voltage converter 42 converts 9V, the out voltage output from the fuel cell group 2, to output a voltage of 8.4 v and a current of 0.91 A for driving the load 8 and charging the secondary cell group 6 when the load require a driving current less than 0.91 A. When current required by the load 8 is increased to 1.5 A, it is obvious that the output current from the converter 42 is not enough. The shortage current, 0.59 A(=1.5 A−0.91 A), is now provided by the discharge of the secondary cell group 6 to the load 8, resulting a voltage decrease of the output voltage of the secondary cell group 6 and reducing the voltage of the negative terminal of the comparator U1. When voltage of the negative terminal is less than the node 22, the switch circuit 44 is turned on, such that the load 8 directly receive the driving current provided by the fuel cell group 2.

Due to the turn on of the switch circuit 44, output voltage of fuel cell group 2 is pulled down by the secondary cell group 6 and the load 8, therefore provides higher current to drive the load 8. If the secondary cell group 6 only provides current of 0.2 A, the output current of the fuel cell group 2 is increased from 1 A into 1.3 A and its output voltage is changed into 7.8V according to a I/V curve in FIG. 6 to fulfill the required current, 1.5 A, of the load 8. This implies that the output voltage of the secondary cell group 6 is also 7.8V. In case that the current required by the load 8 becomes 1.3 A, the secondary cell group 6 is neither charged nor discharged, maintaining its output voltage as 7.8V. If the current required by the load 8 is further decreased to be less than 1.3 A, fuel cell group 2 outputs more current than that required by the load 8 and the extra current is used to charge secondary cell group 6, resulting in a voltage increase of the output voltage of secondary cell group 6. This voltage increase also decreases the current output from the fuel cell group 2 as depicted by FIG. 6. As charged, the output voltage of secondary cell group 6 may go high above 8.4V to make the negative terminal of the comparator U1 higher than that at the node 22, turning off the switch circuit 44 to disconnect the direct connection between the secondary cell group 6 and the fuel cell group 2.

In conclusion, at the moment when the current required by the load 8 makes the voltage of secondary cell group 6 less than 8.0V, the output voltage of the fuel cell group 2 will be within the operative voltage range A and the switch circuit 44 is turned on to form a direct connection between fuel cell group 2 and the secondary cell group 6. When the load 8 requires less current and therefore secondary cell group 6 is charged to have an output voltage higher than 8.4V, the maximum operative voltage, the negative terminal of the comparator U1 becomes higher than that at the node 22, turning off the switch circuit 44 and disconnecting the direction connect. The turned-off switch circuit 44 also enables or activates the voltage convert 42. Even the voltage directly outputted by the fuel cell group 2 may goes away from the operative voltage range, the voltage convert 42 can still converts it to provide an output voltage within the operative voltage range, thereby keeping the secondary cell group 6 in operative condition.

When the secondary cell group 6 is discharged to a preset value, the secondary cell group 6 and the fuel cell group 2 in together directly drive the load 8, saving the power lost during DC/DC convertion. When the current required from the load 8 is reduced, voltage output from the secondary cell group 6 may increase. When the output voltage from the secondary cell group 6 exceeds 8.4V, the switch circuit 44 is turned off and voltage convert 42 converts the voltage output from the fuel cell group 2 to a set voltage to the secondary cell group 6 and the load 8, thereby avoiding providing an over high voltage onto the secondary cell group 6.

### Third Embodiment

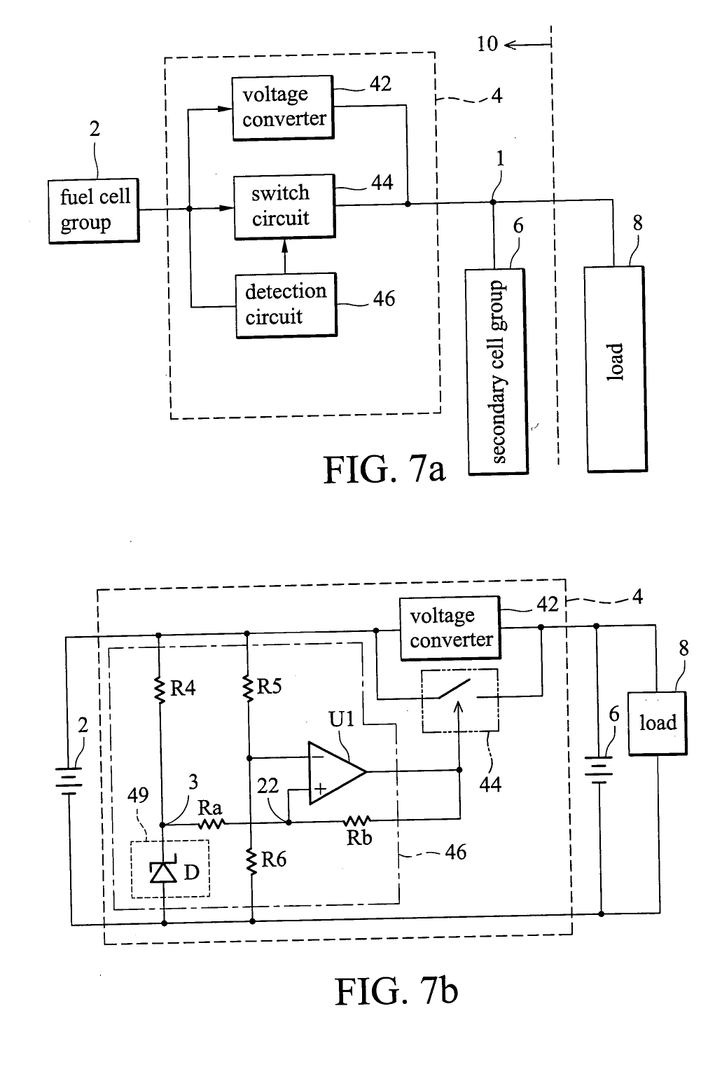

FIG. 7a is a block diagram of a power supply device according to a third embodiment of the present invention. The control unit 4 comprises a voltage converter 42, a switch circuit 44, and a detection circuit 46. The voltage converter 42 is connected with the switch circuit 44 in parallel, coupled between the fuel cell group 2 and the secondary cell group 6, and converts voltage output from the fuel cell group 2 to a set voltage within the operative voltage range of the secondary cell group 6. The detection circuit 46 detects the output voltage from the fuel cell group 2.

When the voltage output from the fuel cell group 2 is less than a first preset value, the detection circuit 46 would turn on the switch circuit 44 to directly provide the output voltage from the fuel cell group 2 to the secondary cell group 6 and the load 8.

When the voltage output from the fuel cell group 2 exceeds a second preset value, the detection circuit 46 would turn off the switch circuit 44 to provide the set voltage to the secondary cell group 6 and the load 8.

FIG. 7b is a circuit diagram according to the third embodiment of the present invention. FIG. 7b is similar to FIG. 5b except that the detection circuit 46 detects the voltage output from the fuel cell group 2. Operations of the third embodiment and the second embodiment are the same.

### Fourth Embodiment

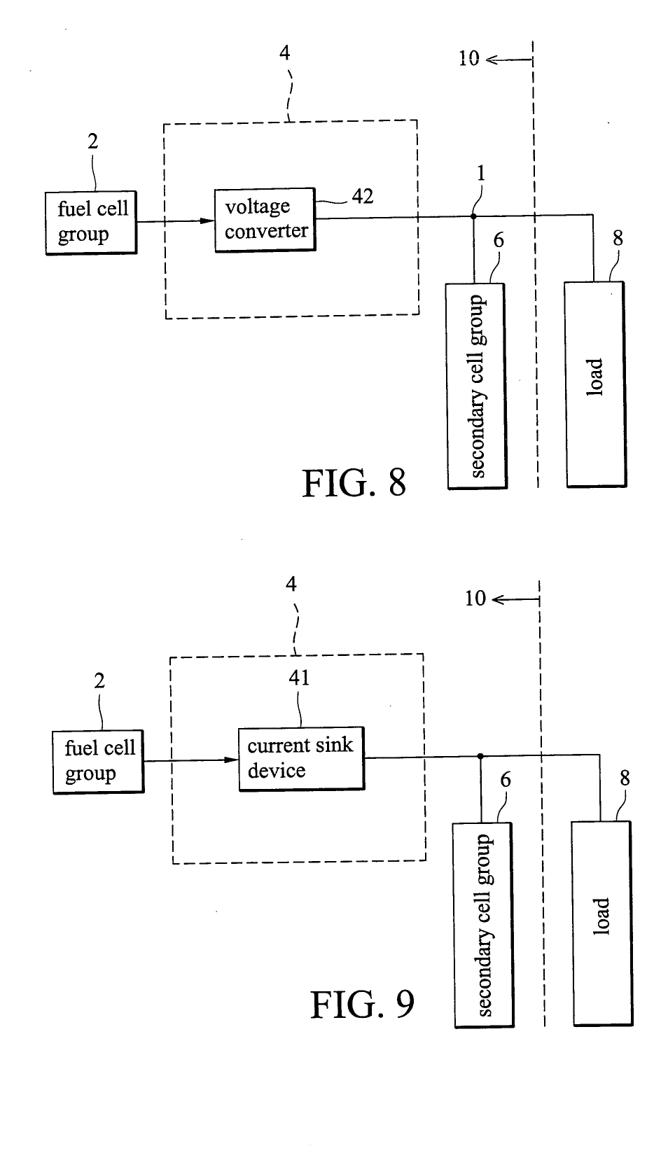

FIG. 8 is a block diagram of a power supply device according to a fourth embodiment of the present invention. The control unit 4 is a voltage converter 42 comprising a minimum input voltage and a set voltage. When the voltage output from the fuel cell group 2 exceeds the minimum input voltage, the voltage converter 42 provides the set voltage to the secondary cell group 6 and the load 8. When the voltage output from the fuel cell group 2 is less than or equal to the minimum input voltage, the voltage converter 42 provides a voltage less than the set voltage to the secondary cell group 6 and the load 8. The set voltage is less than or equal to a maximum voltage of the operative voltage range of the secondary cell group 6.

The voltage converter 42 is a step-down converter, such as a switching power converter or a linear DC voltage regulator circuit. In this embodiment, the switching power converter could use an integrated circuit MC34063, while the linear DC voltage regulator circuit an integrated circuit LM317.

The voltage drop-off between the input and output voltage of the LM317 would be no less than 1V. If the set voltage is 8.4V, the output voltage from the fuel cell group 2 preferably exceeds 9.4V to provide a fixed output voltage as the set voltage to the secondary cell group 6 and the load 8. When the output voltage from the fuel cell group 2 is less than 9.4V, the voltage converter 42 may not sustain it's output voltage as high as 8.4V.

While using a switching regulator circuit, the voltage converter 42 should be set to output 8.4V while the output voltage of the fuel cell group 2 exceeds the minimum required input voltage of the voltage converter 42. If the output voltage of the fuel cell group 2 is lower than the minimum required input voltage of the voltage converter 42, the voltage converter 42 would output a voltage lower than 8.4V and than the output voltage from the fuel cell group 2 about 0.5V˜1.5V, to the secondary cell group 6 and the load 8, depended on the consumed current. While the output voltage of the fuel cell group 2 is lower than the minimum input voltage of the voltage converter 42, the switching regulator circuit should work on the maximum duty cycle to transfer power to the secondary cell group 6 and the load 8, and the voltage drop-off between its input and output voltage would be the transfer loss.

Although the voltage converter 42 experiences voltage drop-off, the embodiment of the present invention adjusts the voltage of the maximum power of the fuel cell group 2 to be equal to or less than the set voltage of the secondary cell group 6, it still possible to make the best use for the maximum output power range of the fuel cell group 2, but still avoid to exceed the limit voltage of the secondary cell group 6. Since the second and the third embodiment of the invention both have a direct connect switch circuit for bypassing the maximum power output of the fuel cell group 2, their efficiency would be better than the fourth embodiment.

### Fifth Embodiment

FIG. 9 is a block diagram of a power supply device according to a fifth embodiment of the present invention. The control unit 4 is a current sink device 41 containing the output voltage from the fuel cell group 2 within the operative voltage range of the secondary cell group 6.

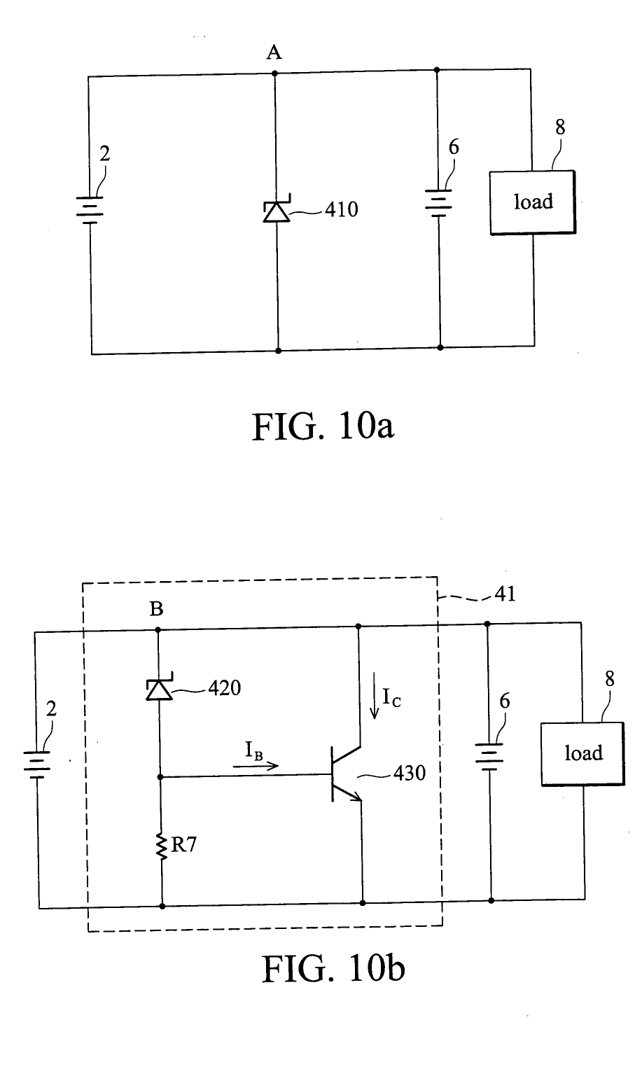

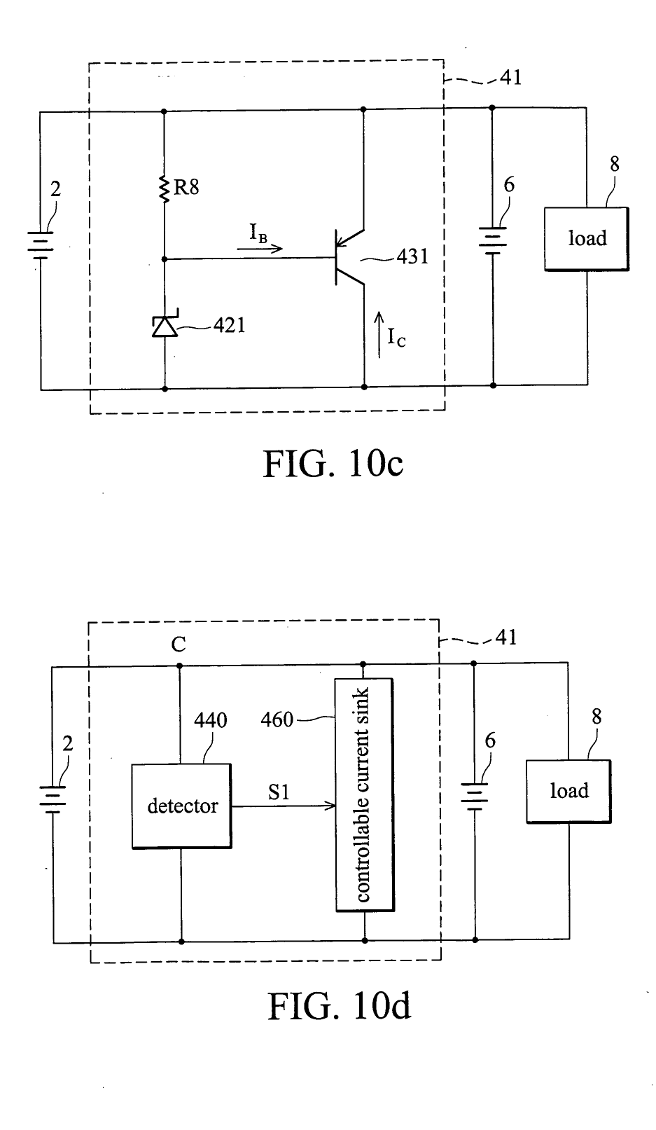

FIG. 10a is a first circuit diagram according to the embodiment. The current sink device 41 is a zener diode 410 providing a reference voltage as the breakdown voltage thereof. In this embodiment, since the operative voltage range of the secondary cell group 6 is between 6.5V and 8.4V, the breakdown voltage is set as 8.4V.

When the output voltage from the fuel cell group 2 exceeds 8.4V, the zener diode 410 is turned on, driving the portion of the driving current provided by the fuel cell group 2 into the zener diode 410. Thus, voltage of the node A is maintained at 8.4V. When the voltage output from the fuel cell group 2 is less than 8.4V, the zener diode 410 is turned off, providing the voltage output from the fuel cell group 2 to the secondary cell group 6 and the load 8.

FIG. 10b is a second circuit diagram according to the embodiment. The current sink device 41 comprises a zener diode 420, resistor R7, and a NPN transistor 430. Voltage sum of the breakdown voltage of the zener diode 420 and voltage between the base and emitter VBE is a reference voltage. When voltage of the node B exceeds the reference voltage, the zener diode 420 is turned on to generate current IB to turn on the NPN transistor 430.

Since the operative voltage range of the secondary cell group 6 is between 6.5V and 8.4V, the voltage sum is not more than 8.4V. If voltage between the base and emitter VBE is 0.7V, the breakdown voltage of the zener diode 420 is 7.7V to avoid secondary cell group 6 receiving a higher voltage.

When the voltage output from the fuel cell group 2 exceeds 8.4V, the zener diode 420 is turned on, driving the driving current provided by the fuel cell group 2 to the zener diode 420.

In an ideal state, driving current is the current IB of the NPN transistor 430. When the driving current provided from the fuel cell group 2 increases due to the fuel cell voltage rising above the reference voltage, the base current IB of the NPN transistor 430 does, as well. Thus, a current Ic of the NPN transistor 430 gets even higher and therefore decreases the voltage of node B as low as the reference voltage.

When the voltage output from the fuel cell group 2 is less than 8.4V, the zener diode 420 and the NPN transistor 430 is turned off, the current from fuel cell group 2 then fully used in charging the secondary cell group 6 and driving the load 8.

When voltage between two terminals of the zener diode 420 is less than the breakdown voltage, leakage current enters the zener diode 420. Thus, the resistor R7 avoids current leakage into the base of the NPN transistor 430. The NPN transistor 430 can be a PNP transistor as shown in FIG. 10c. Variation between PNP and NPN components is will known to those skilled in the field.

FIG. 10d is a fourth circuit diagram according to this embodiment. The current sink device 41 comprises a detector 440 and a controllable current sinker 460. When the output voltage from the fuel cell group 2 exceeds the maximum voltage of the operative voltage range of the secondary cell group 6, the detector 440 outputs an adjustment signal S1. The controllable current sinker 460 receives the signal S1 and controls the sinking current provided from the fuel cell group 2. The sinking current of the current sinker is adjusted to make the output voltage of the fuel cell group 2 not exceed the upper limit of operation range.

When the output voltage from the fuel cell group 2 is within the operative voltage range of the secondary cell group 6, the sinking current is off and all the driving current provided from the fuel cell group 2 flows into the secondary cell group 6 and the load 8.

Additionally, the secondary cell group 6 comprises a protection device, such that the voltage output from the secondary cell group 6 does not fall less than the minimum voltage. When the voltage output from the secondary cell group 6 is less than the minimum voltage, the connection between the secondary cell group 6 and the load 8 is cut off by the protection device. The protection device is well known to those skilled in the field.

In summary, since the voltage output from the fuel cell group is changed by the load 8, the present invention adjusts output voltage corresponding to a preset power and controls the output voltage within the operative voltage range of the secondary cell group 6. When the load 8 requires large current, the fuel cell group 2 does not utilize a voltage converter and directly provides the required current to the load 8.

While the invention has been described by way of example and in terms of the preferred embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A power supply method comprising:
providing a secondary cell group comprising an operative voltage range;
providing a fuel cell group comprising a maximal output power and a corresponding voltage; and
adjusting the fuel cell group to maintain the corresponding voltage not higher than the upper limit of the operative voltage range.

2. The power supply method as claimed in claim 1, further comprising converting a first output voltage from the fuel cell group to a first voltage within the operative voltage range when the first output voltage exceeds the operative voltage range.

3. A power supply device, comprising:
a secondary cell group comprising an operative voltage range;
a fuel cell group comprising a fuel cell voltage and
a control unit coupled between the fuel cell group and secondary cell group, outputting a first voltage within the operative voltage range to the secondary cell group when the fuel cell voltage is outside the operative voltage range, wherein the control unit outputs a first output voltage from the fuel cell group to the secondary cell group when the first output voltage is within the operative voltage range.

4. A power supply device, comprising:
a secondary cell group comprising an operative voltage range; and
a fuel cell group comprising a maximal output power and a corresponding voltage not higher than the upper limit of the operative voltage range.

5. The power supply device as claimed in claim 4, further comprising a control unit coupled between the secondary cell group and the fuel cell group, outputting a first voltage within the operative voltage range to the secondary cell group.

6. The power supply device as claimed in claim 5, wherein the control unit is a current sink device clamping a first output voltage from the fuel cell group within the operative voltage range.

7. The power supply device as claimed in claim 6, wherein the current sink device is a zener diode.

8. The power supply device as claimed in claim 6, wherein the current sink device comprises:
a detector outputting an adjustment signal when the first output voltage exceeds a maximum voltage of the operative voltage range; and
a controllable current sinker maintaining output current from the fuel cell group and clamping the first output voltage to within the operative voltage, range according to the adjustment signal, wherein the secondary cell group receives the first output voltage when is within the operative voltage range.

9. The power supply device as claimed in claim 8, wherein the detector comprises a zener diode and the controllable current sinker an npn transistor.

10. The power supply device as claimed in claim 8, wherein the detector comprises a zener diode and the controllable current sinker a pnp transistor.

11. The power supply device as claimed in claim 5, wherein the control unit is a step-down DC/DC converter.

12. The power supply device as claimed in claim 11, wherein the step-down DC converter is a linear DC voltage regulator circuit.

13. The power supply device as claimed in claim 11, wherein the step-down DC converter is an DC switching power supply circuit.

14. The power supply device as claimed in claim 5, wherein the control unit comprises:
a switch circuit coupled between the fuel cell group and the secondary cell group; and
a detection circuit detecting a second voltage output from the secondary cell group, wherein the detection circuit turns on the switch circuit to directly connect the fuel cell group and the secondary cell group when the second output voltage is less than a first preset voltage of the operative voltage range and the detection circuit turns off the switch circuit to disconnect the fuel cell group and the secondary cell group when the second output voltage exceeds a second preset voltage of the operative voltage range.

15. The power supply device as claimed in claim 14, wherein the control unit further comprises a voltage converter connected with the switch circuit in parallel, outputting the first voltage.

16. The power supply device as claimed in claim 15, wherein the switch circuit is a transistor or a relay.

17. The power supply device as claimed in claim 15, wherein the voltage converter is a step-down DC converter.

18. The power supply device as claimed in claim 5, wherein the control unit comprises:
a switch circuit coupled between the fuel cell group and the secondary cell group;
a voltage converter connected with the switch circuit in parallel converting the first output voltage to the first voltage; and
a detection circuit detecting the first output voltage, wherein the detection circuit turns on the switch circuit to directly provide the first output voltage to the secondary cell group when the first output voltage is less than a third preset value of the operative voltage range and the detection circuit turns off the switch circuit providing the first voltage to the secondary cell group when the first output voltage exceeds a fourth preset value of the operative voltage range.

19. The power supply device as claimed in claim 18, wherein the switch circuit is a transistor or a relay.

20. The power supply device as claimed in claim 18, wherein the voltage converter is a step-down DC converter.

21. The power supply device as claimed in claim 20, wherein the buck DC converter is a linear DC voltage regulator circuit.

22. The power supply device as claimed in claim 21, wherein the step-down DC converter is a switching power supply.

23. The power supply device as claimed in claim 4, wherein the secondary cell group comprises lithium ion secondary, nickel hydrogen, or lead acid batteries, or the combination thereof.

24. The power supply device as claimed in claim 4, wherein the fuel cell group comprises direct methanol fuel cells.
